(19) United States
(12) Patent Application Publication
(10) Pub. No.: US 2026/0006684 A1
(43) Pub. Date: Jan. 1, 2026

(54) High Temperature Edge Heater

(71) Applicant: Battelle Memorial Institute, Columbus, OH (US)

(72) Inventors: Katherine M. Palmer, Galloway, OH (US); Kurt M. Bosworth, Woodstock, OH (US); Matthew Colachis, Columbus, OH (US)

(21) Appl. No.: 18/653,965

(22) Filed: May 2, 2024

Related U.S. Application Data
(60) Provisional application No. 63/499,492, filed on May 2, 2023.

(51) Int. Cl. H05B 3/28; H01F 13/00; H05B 3/14; H05B 3/16

(52) U.S. Cl. CPC H05B 3/283; H05B 3/145; H05B 3/16; H01F 13/003; H05B 2203/013

(57) ABSTRACT

An edge heater comprised of a resistive heating sheet having an edge that is relatively hot because the edge is located close to a constriction in the electrical pathway through the resistive heating sheet. The resistive heating sheet can be made with carbon nanotubes (CNTs). Methods of heating objects using the edge heater and methods of making the edge heater are also described.

### RELATED APPLICATIONS

This application claims the priority benefit of U.S. Provisional Patent Application Ser. No. 63/499,492 filed 2 May 2023.

### GOVERNMENT RIGHTS

This invention was made with Government support under DTRA Contract No. 2019-370 U.S. Department of Defense. The Government has certain rights in the invention.

### INTRODUCTION

The Defense Threat Reduction Agency (DTRA) requires simple and effective localized heater technologies for removing or disabling objects/devices including trackers and IEDs that are attached to the exterior of a vehicle via magnets or other means. DTRA is pursuing this technology because current techniques do not meet mission requirements or warfighter needs. Typically, techniques of this nature are “brute force”, requiring physical contact, proximity of personnel to the device, and leverage (e.g. using a crowbar). These approaches are onerous and often dangerous. To overcome this technology gap, the alternative is to use small, localized sources of very high heat and pressure to disable the device from a safe distance.

A heating device, described in U.S. Pat. No. 11,937,342 was developed to be capable of conforming to a curved surface and quickly applying intense heat to a small area. The inventive spot heater has numerous applications. For example, the spot heater can be used in a seat heater or a heater that can melt a hole in a plastic film (for example, in a device in which a plastic film separates reactive components so that the activation of the heater initiates a chemical reaction. Many sensors require elevated temperature to operate. These often employ micro hot plates that can be provided by the inventive heaters. Examples include gas sensors, pressure sensors, humidity sensors. Lab on a chip or other diagnostics also require embedded heaters such as the inventive type. The heaters can be used in a vaping device. The heaters can be used in medical devices to warm a drug for injection and reduce warm-up time after removal from refrigerator. Other applications include (but are not limited to): non-hazardous non-explosive thermal decoy flares; destructive heater for computer boards for anti-tampering; localized on-demand thermal curing of adhesives for small constricted areas; edge welding, fuses, and a pressure relief valve that can be powered by a battery.

Exterior Vehicle-Attached Device Removal (EVADR), described in U.S. Patent Publication No. 2022/0090895, is an experimentation and proof of concept effort to evaluate the ability of removing an attached device from a surface (vehicle exterior or acceptable surrogate) in a timely fashion using these alternative techniques. This localized heating technology can also be used in combination with Battelle's ChemEngine technology, which can produce at least 48 psi of pressure per 25 mL of non-hazardous chemical volume in less than 3 seconds. This type of small on demand pressure generation system may also assist in removal of an IED from a vehicle surface, so even a partially demagnetized IED may be removed with less brute force. Adhesive bonds and mechanical fasteners weakened after exposure to high localized heat may be forced apart with pressure generated from ChemEngine devices. This EVADR effort will bring significant value to the DoD mission by increasing the distance and decreasing the interaction between the IED disabler and the IED thereby increasing warfighter safety.

The objective of this project was to test prototype edge heaters capable of sustaining temperatures of at least 750° F. over time periods exceeding 30 minutes and determine if they can demagnetize a rare earth magnet that would allow for easier and safer removal of improvised explosive devices (IEDs) or other tracking devices.

### SUMMARY OF THE INVENTION

The invention provides an edge heater that is designed to provide heat along one edge of a resistive heater. Preferably, the resistive heater layer is a CNT network layer. The heating edge may be straight, lacking in angles and curves. In other configurations, the heating edge conforms to the shape of the object being heated. The edge heater may further comprise a thermally conductive material layer disposed on one side of the resistive heating sheet in a constriction region that extends to the heating edge. Preferably, the thermally conductive material layer has a thickness that is at least 10 times less than length and at least 10 times less than width. A thermally conductive material can be disposed adjacent to the constricted area; the thermally conductive material layer can be triangular with one edge of the triangle perpendicular to the central longitudinal axis of the edge heater.

In one aspect, the invention provides an edge heater, comprising: a resistive heating sheet having dimensions of length, width, and thickness; wherein the thickness is at least 10 times less than length and at least 10 times less than width; first and second electrical leads connected to the resistive heating sheet; wherein the resistive heating sheet provides an electrically-conductive pathway from the first to the second electrical lead; wherein the resistive heating sheet comprises a heating edge along the width of the resistive heating sheet; wherein the edge opposite the heating edge comprises a reduced portion that creates a constriction region for the flow of electricity through the resistive heating sheet from the first to the second lead; and wherein the resistive heating sheet has an asymmetrical shape in the length dimension such that, if a plane is drawn perpendicular to length and thickness and bisecting the constriction region, there is no reflection of the resistive heating sheet through the plane that extends over more than 20% of the heating edge (i.e., 20% of the width of the resistive heating sheet that comprises the heating edge) and wherein the area of the resistive heating sheet on the heating edge side of the plane is less than the area of the resistive heating sheet on the side of the plane opposing the heating edge.

The phrase “there is no reflection of the resistive heating sheet through the plane that extends over more than 20% of the heating edge” means that there is no mirror plane symmetry that extends over more than 20% of the heating edge. This also means that a reflection from the non-heating-edge side of the plane through the plane will match up with the heating edge for no more than 20% of the width of the heating edge.

For a perfect bow tie having plane drawn perpendicular to length and thickness and bisecting the constriction region, the reflection of the bow tie through the plane extends over 100% of the tie's edge (the bow tie is symmetric through a horizontal plane while pants are asymmetric through a horizontal plane). If the edge heater has a pants design, then the plane drawn perpendicular to length and width and bisecting the constriction region is drawn through the plane where a belt would fit on a pants.

In another aspect, the invention provides an edge heater comprising: a resistive heating sheet having dimensions of height, width, and thickness and is asymmetrical in shape; wherein the thickness is at least 10 times less than the length and at least 10 times less than the width; wherein an edge that is a heating edge comprises a reduced portion, or a gap, that creates a constriction region for the flow of electricity through the resistive heating sheet from the first to the second lead; wherein if a plane or a transverse axis were to be drawn through the constriction region such that the axis were to bisect the constriction region in the width direction, the sheet on one side of the axis would extend further at every point away from the axis as compared to the other side, except for a single point, or a region that makes up 10% or less of the sheet's width, on both sides of the axis that is equidistant to the axis and lies on a single longitudinal axis; first and second electrical leads connected to the resistive heating sheet; wherein the resistive heating sheet provides an electrically-conductive pathway from the first lead through the constriction region to the second electrical lead; and wherein the resistive heating sheet comprises a heating edge along the width of the resistive heating sheet that is closer to the axis than the sheet's edge that opposes the heating edge.

In a further aspect, the invention provides a system for heating an object, comprising; an edge heater further comprising: a resistive heating sheet having dimensions of height, width, and thickness and is asymmetrical in shape; wherein the thickness is at least 10 times less than the length and at least 10 times less than the width; wherein if a plane or transverse axis were to be drawn through the gap such that the axis bisects the gap, the sheet on one side of the axis would extend further at every point away from the axis as compared to the other side, except for a single point, or a region that makes up 10% or less of the sheet's width, on both sides that is equidistant to the transverse axis and lie on a single longitudinal axis; first and second electrical leads connected to the resistive heating sheet; wherein the resistive heating sheet provides an electrically-conductive pathway from the first lead through a constriction region to the second electrical lead; wherein the resistive heating sheet comprises a heating edge along the width of the resistive heating sheet; wherein an edge opposite the heating edge comprises a reduced portion, or a gap, that creates the constriction region for the flow of electricity through the resistive heating sheet from the first to the second lead; an object to which the edge heater is applied is touching the edge heater on the heating edge but not on other sides of the resistive heating sheet; and an electrical power source connected to the edge heater.

In another aspect, the invention provides a method of heating an object, comprising contacting the heating edge of the edge heater of any of the above claims with the object. The object is not limited but may be, for example, a magnet.

In another aspect, the invention provides a method of making an edge heater, comprising: providing a dielectric layer; bonding a shaped resistive heating sheet to the dielectric layer having a constricted region; and applying a first lead and a second lead to the resistive heating sheet on opposing sides of the constricted region.

In any of its aspects, the invention can be further characterized by one or any combination of the following: thickness of resistive heating sheet varies by 20% or less, or 10% or less, or 5% or less; wherein the resistive heating sheet is bonded to an insulating sheet, preferably bonded by a ceramic adhesive; wherein the edge heater can sustain a temperature of between 500° F. (260° C.) and 2000° F. (1040° C.) for a time interval of 30 minutes, or 60 minutes, preferably when powered by a 9- to 20-volt battery having a charge of 50 to 200 amp-hours; a conductive metal, preferably copper, in the form of a braid to act as leads; a conductive adhesive bonding the leads to the resistive heating element; the constriction region has a width that is at least 20% or 40% or 60% less than the average width; wherein the resistive heating sheet comprises bucky paper; wherein the resistive heating sheet comprises at least 60 g/m² of CNTs. or at least 100 g/m² of CNTs or in the range of 50 to 400 g/m² of CNTs; wherein the area of the resistive heating sheet on the side of the plane opposing the heating edge is at least two times greater or at least 3 times greater or in the range of 2 to 100 times greater than the area of the resistive heating sheet on the heating edge side of the plane; wherein the resistive heating element has an appearance of 2D pants; wherein the thermally conductive material layer comprises a silver-containing adhesive is applied in a triangular shape at an intersection of a pair of legs of the pants-shaped heating element (the legs extend in the direction of length); wherein the adhesive that makes contact between the resistive heating element and kiln paper is a magnesia adhesive; wherein a ceramic fiber blanket, comprising alumina and silica fibers, is applied over one or both sides of the thin heating element to provide thermal insulation; the edge heater of concept 1 is powered by rechargeable batteries capable of producing at least a voltage of 5 volts and at least a current of 1 amp; wherein the edge heater of is able to reduce the pull strength of rare earth magnets to 30-50% or less of original pull strength after thermal exposure; wherein the ratio of length to width of the resistive heating layer is 2 to 1, or 1.5 to 1, or between 1.0-2.5 to 0.5-2.0; wherein the heating edge forms an angle with the constriction region with the apex at the constriction region, wherein the angle is at least 160 degrees or at least 170 degrees or between 160 and 180 degrees; wherein the heating edge is planar such that the heating edge projects from said plane by a uniform distance (angle is 180 degrees); wherein the length of the edge on the edge heater is 1.5 inches, or 2 inches, or between 0.75 inches and 3.5 inches; wherein the width of the edge heater is 1 inch, or 1.5 inches, or between 0.5 and 3 inches; wherein the thickness of the edge heater is between 25 μm and 150 μm; wherein the thickness is at least 20 times less than the length and at least 20 times less than the width; wherein electricity is passed through the constriction region of the resistive heating sheet and wherein the highest temperature of the resistive heating sheet is at least 2° C. (or at least 5° C.) hotter than the average temperature of the object; wherein the object comprises a magnet; wherein the magnet is a rare earth magnet, or a neodymium magnet or a samarium cobalt magnet; wherein the magnet is an IED magnet; wherein the dielectric layer is paper, preferably kiln paper; wherein the adhesive is a conductive adhesive preferably filled with a metal such as silver or copper; wherein the leads comprise a copper braid preferably bonded to the resistive heating sheet by a conductive adhesive; and/or heating the assembly to cure the adhesive; wherein the resistive heating sheet has a pants shape and applying a conductive adhesive in the crotch area-preferably in a triangle shape.

As applied as a method of removing magnets, characteristic properties of the invention include:
an increase in the ambient temperature of an IED, or any object, attached substrate to at least 750° F.;
reducing the pull force of IED magnets, or any selected magnet, by at least 50% by approaching or exceeding Curie temperature of the magnet;
reduced adhesion of structural adhesives by at least 25% by softening or thermal degradation;
weakening of mechanical fasteners by softening or thermal degradation. Metal fasteners will require the highest temperature for degradation.

### Glossary

The term “carbon nanotube” or “CNT” includes single, double and multiwall carbon nanotubes (SWNT, DWNT and MWNT, respectively) and, unless further specified, also includes bundles and other morphologies. Additionally, the CNTs can be any combination of these materials, rather than a specific type; for example, a CNT composition may include a mixture of single and multiwall CNTs, or it may consist essentially of DWNT and/or MWNT, or it may consist essentially of SWNT, etc. CNTs have an aspect ratio (length to diameter) of at least 50, preferably at least 100, and typically more than 1000.

Unless otherwise specified, “conductive” means electrically conductive and typically also thermally conductive such as metals or metal-filled adhesives.

Gap—A gap is a narrowed portion of the edge heater where constriction of current flow occurs. For example, in a bow-tie configuration, the “tie” towards the center of the bow-tie is the narrowest portion and would be referred to as the gap. In a “pants” configuration, the gap is the portion between the waist and the crotch. In some embodiments, a single edge heater may comprise more than one gap.

Gap height—Gap height is the shortest dimension of the gap.

Pull force/strength—Pull force, also known as magnetic strength or holding force, is the measure of how much weight a magnet can support when adhered to a flat, ferrous surface. It represents the force required to pull a magnet directly away from a flat, thick, and ground steel plate.

Thickness, length, and width—These dimensions refer to the maximum dimensions of each, wherein the thickness is the shortest dimension and the length is the longest dimension. Thickness, length, and width are mutually perpendicular and are along the vertical (or normal), longitudinal, and lateral axes, respectively.

Various aspects of the invention are described using the term “comprising;” however, in narrower embodiments, the invention may alternatively be described using the terms “consisting essentially of” or, more narrowly, “consisting of.” The term “such that” has the conventional meaning of “to the extent that” or “which satisfies the condition that.”.

### BRIEF DESCRIPTION OF THE DRAWINGS

FIG. 1. Pull-off strength chart for a commercial magnetic tracker device.

FIG. 2. Image of fully constructed Edge Heater.

FIG. 3. Computational mesh of heater. Here, the heater has the shape of pants. The length direction is like that of the pants' length. Width is the waist direction. The heating edge is the top of the pants (at the waist) and is opposite the crotch area.

FIG. 4. Edge Heater electrical current flow diagram showing the highest current density in the crotch area (i.e., the gap).

FIG. 5. Current density at gap.

FIG. 6. Instron testing apparatus.

FIG. 7. Experimental degradation for Neodymium magnets on car door.

FIG. 8. Experimental degradation for neodymium magnets on car frame.

FIG. 9. Calculated degradation for Neodymium magnets on car door.

FIG. 10. Calculated degradation for Neodymium magnets on car frame.

FIG. 11. Experimental degradation for Samarian Cobalt magnets on car door.

FIG. 12. Experimental degradation for Samarian Cobalt magnets on car frame.

FIG. 13. Photo of Edge Heater placement for magnet tests with three edge heaters contacting a magnet.

FIG. 14. Tracker cases after (left) and before (right) edge heater testing.

### DETAILED DESCRIPTION OF THE INVENTION

The construction materials and design of the edge heaters were designed to meet the temperature and time requirements for thermal degradation of rare earth magnets. While originally designed for very high (2000° F.) temperatures, those heaters burned out after only a few seconds due to the thermal limitations of the supporting materials used for construction. The construction materials and design of the edge heaters have moved through several iterations to maximize the heating temperature and duration before failure. Temperatures of 750° F.+ for up to 60 minutes have been documented using 7 volts/2 amps of supplied power.

Typical high temperature heaters are constructed of wires such as nichrome. They provide either single point heating or heating only along the line of the wire. They are not flexible. Heaters prepared using carbon nanotube can be thin and flexible, and provide heat across a surface area rather than only at the line of the resistive heating wire. Earlier work by Battelle is described in U.S. Pat. No. 11,937,342 and U.S. Patent Publication No. 2022/0090895, which is incorporated herein as if reproduced in full below. While small, very fast, and hot carbon nanotube heaters were designed for short temperature duration, the supporting materials were unable to sustain high heat for long duration (more than a few seconds) before failure. A thin, flexible heater was needed to sustain a minimum of 750° F. for at least 30 minutes in a ½″×1″ area. High temperature supporting materials for the carbon nanotube resistive heater were identified and tested and found to achieve needed durability. Nichrome, silicon carbide and Molybdenum disilicide heating elements are typically used in very high temperature applications for furnaces. These elements are rigid and provide resistive heating only at the element wire surface (line heating) as opposed to surface area heating. There is a need for a thin heating element which can provide high heat to a 2D surface, such as the inside cavity of an oven or to heat a square area. Carbon nanotube resistive heater elements can withstand very high temperatures but due to the fragility of carbon nanotubes (CNT) in sheet (bucky paper) or thin film form, supporting materials which are more mechanically sound and have high heat service temperatures are needed to keep lead attachments and allow for basic manual handling. A combination of materials such as silver silicate adhesive, Magnesium coating, ceramic fiber blanket and kiln paper were all used to support the CNT resistive heater and withstand high temperature above 750° F. for at least 60-minute duration.

Flexible heaters typically use kapton or silicone as supporting materials for metal lead wires. These heaters generally only withstand up to 500° F. service temperature before the silicone and kapton start to degrade. By using materials such as kiln paper and ceramic fiber blanket which are made from alumina and silica fibers, much higher service temperatures are possible. Power is supplied to the carbon nanotube surface heater through copper leads. The electrical connection between the copper and CNT also requires high temperature durability.

Two success criteria were targets for this project. The first was to increase the substrate temperature to at least 750° F. and the second was to reduce the pull-off strength of the magnets by at least 50%. Thermal performance of edge heaters increased the surface temperature of car door panels up to 1821° F. exceeding expectations. This was achieved by using one heater that was powered with 10.5 volts and 3.3 amps. Neodymium magnets found in commercial off-the-shelf (COTS) tracker cases had their pull-off strength thermally reduced to 35% of the original strength exceeding the goal of 50% reduction. This was achieved by powering 3 edge heaters per magnet with 5.7 volts/2 amps for 30 minutes.

These success criteria targets were achieved through evaluating COTS tracker cases, designing appropriate edge heaters and finally thermally degrading the magnets under specific time and temperature exposures. Thermal exposure testing of Neodymium and Samarian Cobalt magnets found that a much longer duration of heat is required, including heating of the metal car door substrate. High-temperature supporting materials such as magnesium adhesive, ceramic fiber paper, and silver silicate adhesive coating were identified and tested on edge heater designs. For safety reasons, these tests were performed on car door panels of about 6″×6″ in a laboratory hood using AC power supply. However, current designs of the heaters can be powered with rechargeable batteries similar to those found in drills or other typical power tools for use in the field.

### Thermal Performance on Vehicle Body Panels

The thermal performance of HeatCoat™ edge heaters in different configurations as applied on typical automotive body panel substrates was tested, evaluating the heat-up rate, thermal maximum (Tₘₐₓ), and localization of this Tₘₐₓ, with intent to achieve at minimum 750° F. Testing included edge heaters of different size and geometries in contact with rare earth magnets (Neodymium and Samarian Cobalt) and measured the current and time needed for the magnet to reach the Curie temperature. Thermal distribution was characterized with high temperature thermocouples and temperature indicating paints. Using the experimental results, Battelle tested and scaled up iteratively to improve the edge heater design as required to achieve performance objectives.

### Results and Discussion

### Commercial Off the Shelf (COTS) Tracker Evaluation

Five different COTS tracker cases were obtained and tested for magnetic pull strength. Upon arrival the trackers contained either 2 or 6 Neodymium magnets. No trackers could be found containing Samarian Cobalt magnets. Detailed CAD drawings of the trackers were created. These detailed drawings provided the information needed when placing edge heaters on the car doors for efficient heating and potential leverage/clearance dimensions for Chem Engine integration hardware.

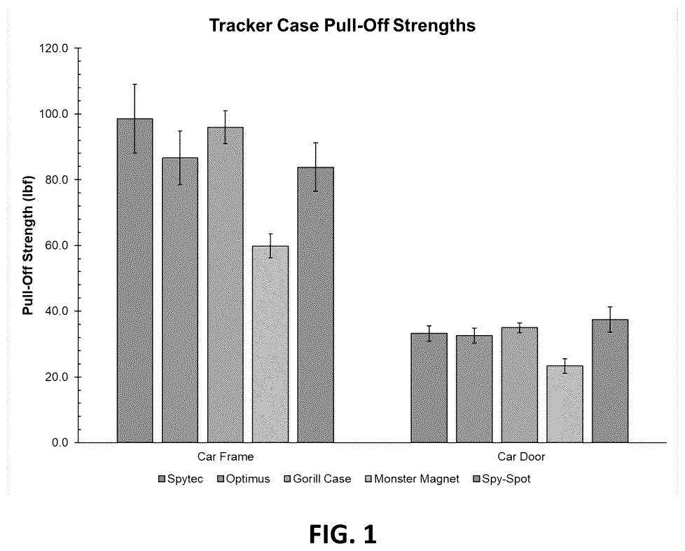

Testing of the pull-off strength of the trackers was performed on both car door panels (thin metal substrate) and thicker steel more similar to car frame components using Instron. These two different locations help provide information on the possible differences that may be encountered in removing magnets from various attachment surfaces. Results are shown in FIG. 1. The car frame requires twice as much strength to pull off magnets than from the car door. The success factors outlined for this phase relate to percent reduction in strength from thermal degradation; however, an overall threshold pull-off strength may be another parameter to consider. For example, a pull-off strength of 10 pounds of force may be reasonable for tracker removal even though it does not meet the 50% strength reduction milestone.

The pull-off strength on thick steel (a value used by vendors for rating magnets) for each tracker was divided by the number of magnets to determine the typical pull strength per magnet. Details of the trackers are in Table 1.

TABLE 1
COTS tracker pull strength

| | | AVG on thick | | |
|---|---|---|---|---|
| | | steel (Car | | |
| | | Frame) | | Difference (Car |
| | # of | Strength | Strength per | Frame:Car |
| Tracker | Magnets | (lbf) | magnet (lb) | Door) |
| SpyTec | 2 | 99 | 49 | 3.0 x |
| Optimus | 2 | 87 | 43 | 2.7 x |
| Gorilla Case | 2 | 96 | 48 | 2.7 x |
| Monster | 2 | 60 | 30 | 2.6 x |
| Magnet | | | | |
| Spy-Edge | 6 | 84 | 14 | 2.2 x |

Due to the large number of thermal studies performed and the destructive nature of the testing, individual magnets purchased from a single source were used for this effort, rather than using dozens of tracker cases. Characterizing the individual magnet pull strength and dimensions of the magnets used on COTS tracker cases was important to identify and obtain the correct magnets for thermal degradation studies.

### Edge Heater Construction and Materials

The construction materials and design of the edge heaters have moved through several iterations to maximize the heating temperature and duration before failure. While not originally identified as risks, various heater material failures that occurred during testing were analyzed and mitigation strategies were implemented until suitable resolutions were found. Failure mechanisms cause/effect/mitigation are shown in Table 2 and represent the different heater designs tested in this project.

TABLE 2
Heater Failures and Mitigations Strategies

| | | Mitigation | |
|---|---|---|---|
| Failure | Cause | Strategy | Result |
| Leads to | Lead wire too | Change lead | Copper braid wire |
| heaters | small for current | wires (0.01″ | carrying higher |
| failing at | load and | copper) to | current load |
| high | overheating | HexWik W54 | eliminated |
| current | | copper braid | failures at leads |
| Low surface | Heaters prepared | Use 60 gsm | Higher heater |
| temperature | with carbon | bucky paper in | temperatures. |
| | nanotube (cnt) | place of cnt coated | Potential to |
| | coated kiln paper | kiln paper | optimize in future |
| | not able to carry | | with thicker |
| | enough current | | bucky paper or |
| | for suitable | | multiple layers of |
| | heating | | bucky paper. |
| Heaters | High current | Fortify the gap | Resbond 906 |
| failing at | density causing | area with high | adhesive showed |
| narrow gap | thermal expansion | temperature | some |
| | and physical | adhesive for added | improvement. |
| | tearing of | toughness during | Aremco 597A |
| | heaters in half | thermal expansion | adhesive provided |
| | breaking the | | longer lasting |
| | circuit | | results. |
| Heaters | Bucky paper tears | Heater attached to | Eliminated failure |
| very | easily and silver | Kiln paper backer | due to handling |
| fragile to | adhesive is | with Resbond 906 | |
| handle | easily removed | and entire heater | |
| | from surface of | is reinforced with | |
| | bucky paper | Kapton tape | |
| | heaters | | |
| Short | Urethane panel | Place high | Eliminated short |
| circuiting | used on car doors | temperature | circuit failures |
| to car door | starts to degrade | resistant | |
| panel metal | around 400° F. | dielectric barrier | |
| after | Also potential to | between heater | |
| several | have to place | surface and car | |
| minutes of | heaters over rust | door. Kiln paper is | |
| 750° F. | areas of bare | too porous and | |
| heating | metal. | thermally | |
| cycle | | insulating on its | |
| | | own but when | |
| | | coated with | |
| | | Resbond 906 | |
| | | provides thicker | |
| | | material that is | |
| | | more thermally | |
| | | conductive to move | |
| | | the heat. | |
| Inconsistent | Variable air gaps | Use high | Reduced |
| thermal | between heaters | temperature | variability and |
| data at | and car door | ceramic fiber | provides easy |
| heater | acting as thermal | blanket pads taped | field option to |
| surface | insulator | over heaters using | apply heaters to |
| | reducing heat | Kapton tape | vertical surfaces |
| | transfer | | like car doors |

Table 3 shows the current list of materials used for edge heater construction. Materials with high service temperature were selected to improve the durability and service life of the heaters. While Kapton tape only has a max service temperature of 500° F., it provides easy attachment to the car door outside of the heating zone and, when used over a fiber blanket, Kapton tape keeps the heater in place while the heater is in direct contact with the car door.

TABLE 3
Edge Heater Materials

| | | Max |
|---|---|---|
| | | Service |
| Material | Purpose | Temp (° F.) |
| Kapton tape | Hold down fiber insulation | 500 |
| | and heater to close contact | |
| | with car door | |
| Ceramic fiber blanket | Thermal insulation | 2,300 |
| Kiln paper (Papyros) | Mechanical durability | 1,600 |
| Resbond 906 (Cotronics) | Adhesion to kiln paper | 3,000 |
| Copper braid (HexWik W54) | Leads to carry current to | 1,984 |
| | heater | |
| High temperature conductive | Electric connection between | 1,700 |
| adhesive (Aremco 597A) | leads and heater | |
| Carbon nanotubes - 60 gsm | Resistive heater | 2,000+ |
| buckypaper (Buckeye | | |
| Composites) | | |

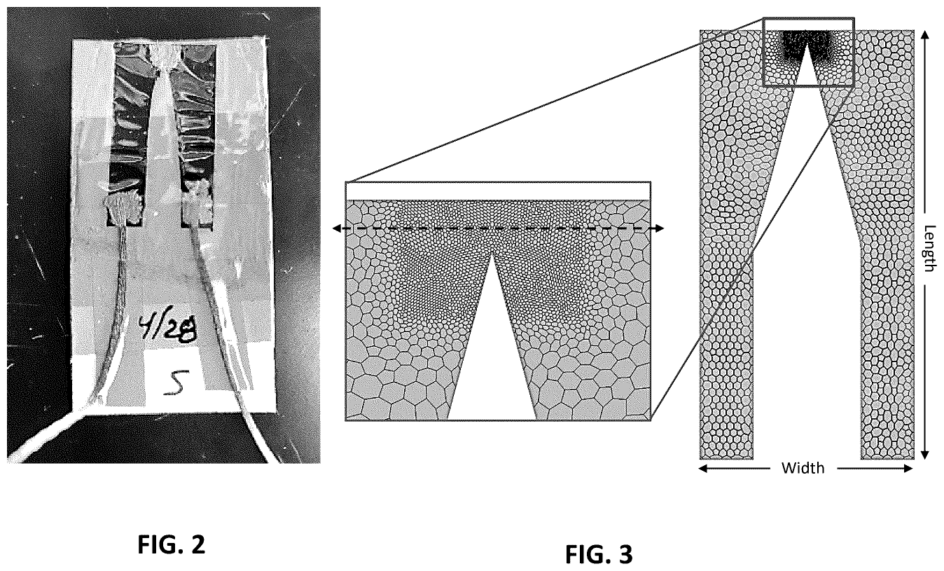

The current list of materials and the procedure for preparing edge heaters and dielectric layer is provided below. FIG. 2 shows a photo of a finished edge heater.

### Materials:

Papyros kiln paper
Buckeye Composites 60 gsm MWCNT buckypaper
Aremco 597A silver adhesive
Cotronics Resbond 906 Adhesive
Hexacon Hexwik W54 copper braid
Kapton tape
Thin silicone strips.
1″×4″ metal coupons for weight
2 Brushes—1 approx ½″ wide, another approx. ⅛″ wide
Water
Oven set to 300° F.
Teflon coated cookie sheet

### Procedure:

1. Cut kiln paper into 1″×2″ pieces—2 for each heater.
2. Cut heater from buckypaper using template and surgical scalpel.
3. Mix Aremco Resbond 906 in small plastic beaker. 10 grams filler to 4.4 grams binder plus about 0.5 grams water to thin. Potlife after mixing is 2 hours.
4. Lightly brush the top surface of one piece of kiln paper with water until saturated. Use Kim Wipe to remove excess water from the surface.
5. Using the wider brush-brush a coat of the Resbond 906 onto the kiln paper where the heater will be placed-approx. 1″×1″.
6. While the Resbond is still wet, gently place one of the heaters onto the surface pressing lightly to set in place. Immediately place a piece of silicone then steel coupon over the heater while working on other heater assemblies.
7. Cut 2 lengths of W54 copper braid—each 2″ long. Straighten with fingers until reasonably flat.
8. Remove the metal coupon weight and silicone strip from over the heater. Place a copper braid on the heater with approx. ¼″ overlap on top of the leg and tape the braid down to the kiln paper below the heater using a small piece of Kapton tape. Repeat with the other braid on the other leg of the heater.
9. Using the smaller brush, apply small dab of Aremco 597A silver adhesive on each end of the copper braid and onto the heater leg. Use the brush tip to slightly move each braid so that adhesive in applied under and over each braid end to provide the most electrical connection. Ensure that silver adhesive is not applied between the two legs. Apply a small triangle of silver adhesive onto the crotch of the heater in a triangle shape with point facing down.
10. Apply the silicone strip over the silver on the copper braids, lightly press with finger to seat and cover with metal coupon weight. No silicone or weight is applied over the silver in the crotch area.
11. Prepare dielectric layer by lightly brush the top surface of one piece of kiln paper with water until saturated. Use Kim Wipe to remove excess water from the surface. Using the wider brush—brush a uniform coat of the Resbond 906 onto the kiln paper—approx. 1″×1.5″.
12. Allow the heater assemblies and dielectric layers to air dry for at least 1 hour.
13. Turn the dielectric layers over, adhesive side to Teflon and cover each with a metal coupon to keep flat during oven cure.
14. Place heater assemblies and dielectric layers in a 300° F. oven for at least 2 hours or overnight.
15. After heat cure, carefully remove weight and silicone strips from over heaters.
16. Place 2 pieces of Kapton tape over the top surface of the entire heater to reinforce silver attachment to bucky paper.

Edge heaters prepared using the procedure and materials described above provide the needed temperatures and durations to meet the thermal degradation milestones for Neodymium magnet degradation on car door panels.

### Thermal Modeling of Edge Heaters

The small size, fast heating rate and high temperatures are challenging to monitor in real time. Most thermal cameras have a maximum temperature limit of around 320° F. High temperature thermocouple monitoring can be performed up to 1600° F.; however this only provides a single point measurement as opposed to understanding heat generated over the entire heater surface. Thermal modeling of edge heater geometry allows for more efficient optimization.

A polyhedral computational mesh was generated for modeling (FIG. 3). The body is represented as a 3D shell element, meaning it consists of only 2D elements but is modeling a 3D body. The gap is modeled more finely with significantly finer polyhedral to better capture gradients as the gap area is the location of most of the heater failures. This area of fast, high heat generation creates physical deformation of the heater due to coefficient of thermal expansion. The physical deformation at the gap of the fragile heater causes the gap to separate, breaking the circuit and resulting in heater failure. Understanding the current flow and temperature gradients at this location of the heater may help to reduce failure and result in a longer lasting, higher temperature heater.

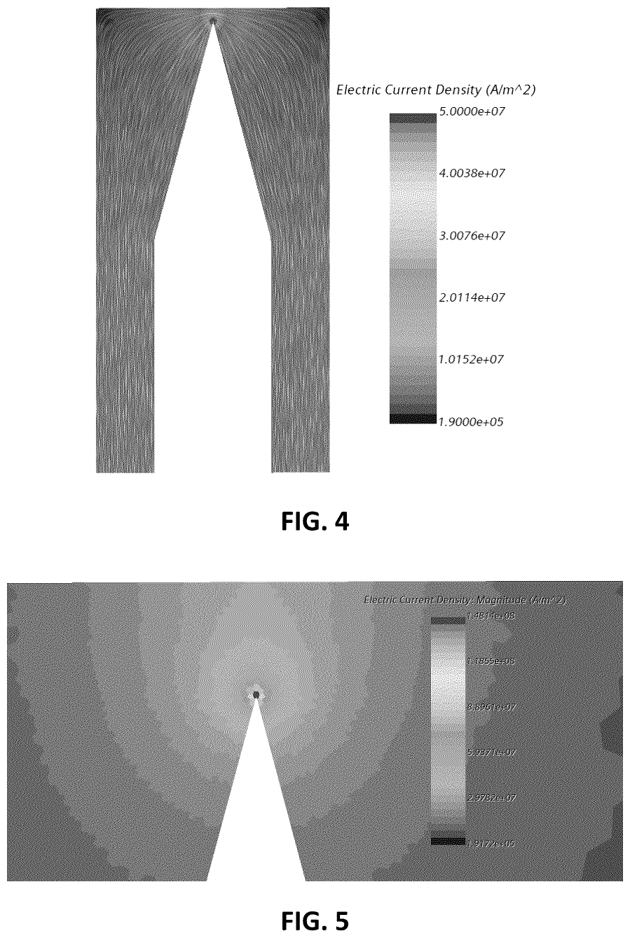

Simulation results, as seen in FIG. 4, show how electrical current flows up one leg, concentrates in the gap, and flows back down the other.

FIG. 5 shows a zoomed-in view of the gap, making it observable that the high power density is located near the top of the gap due to the significant concentration and bending of current flow lines. Additionally, FIG. 5 shows how the maximum concentration of current density really occurs at a single point.

Increasing the mesh density in this area would increase the power density, but decrease the area. In reality, the power density at an infinitesimally small area does not matter, but rather the total power extraction over a fixed area is providing the concentrated heat desired in this edge heater. Results were obtained showing power density near the gap, with a clipped value of 1500 W/in². A peak value over 17000 W/in² was observed, but since this is over such a small area, this is likely more of a theoretical value. Additionally, this value will change with mesh resolution.

### Thermal Degradation of Magnets

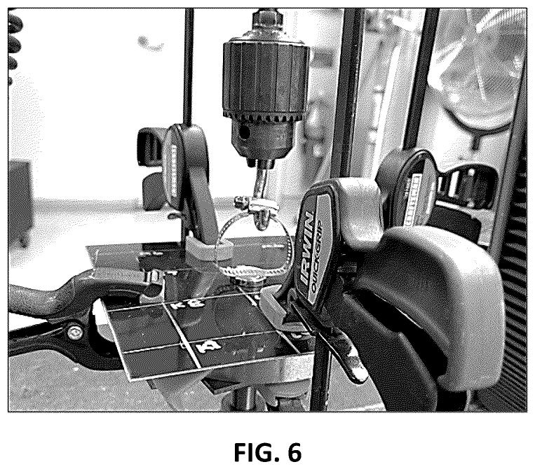

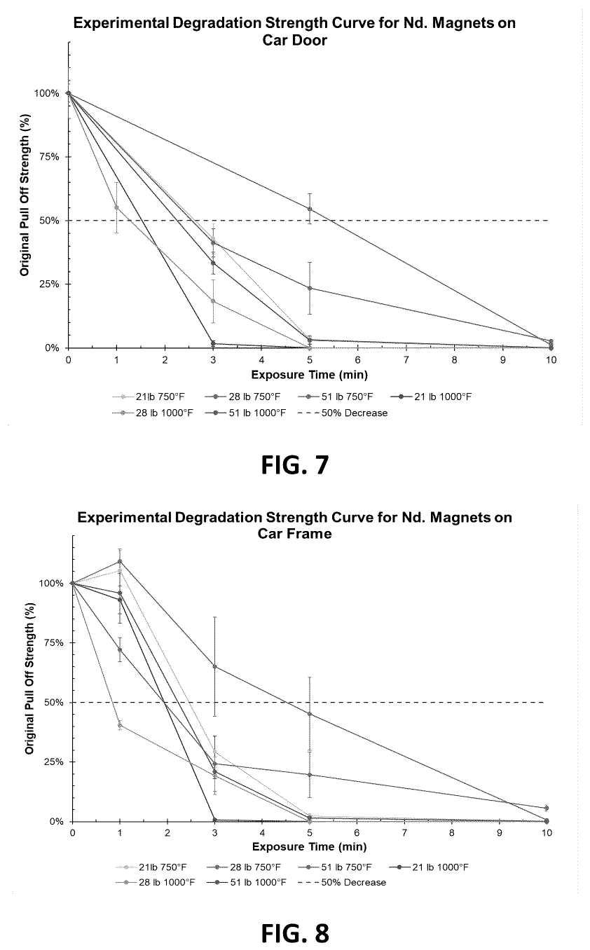

Thermal degradation studies were performed on various Neodymium and Samarian Cobalt magnets in a high temperature muffle furnace. These results provided critical information on the temperatures and exposures times required to thermally degrade the magnets to target pull strengths. The pull strengths were evaluated by pulling on Instron on both car door panels and thick steel to represent a car frame. FIG. 6 shows a photo of the Instron test set up on car doors and thick steel. FIGS. 7 and 8 show the percent of original pull strength after thermal exposure as compared to the original unexposed magnetic strength.

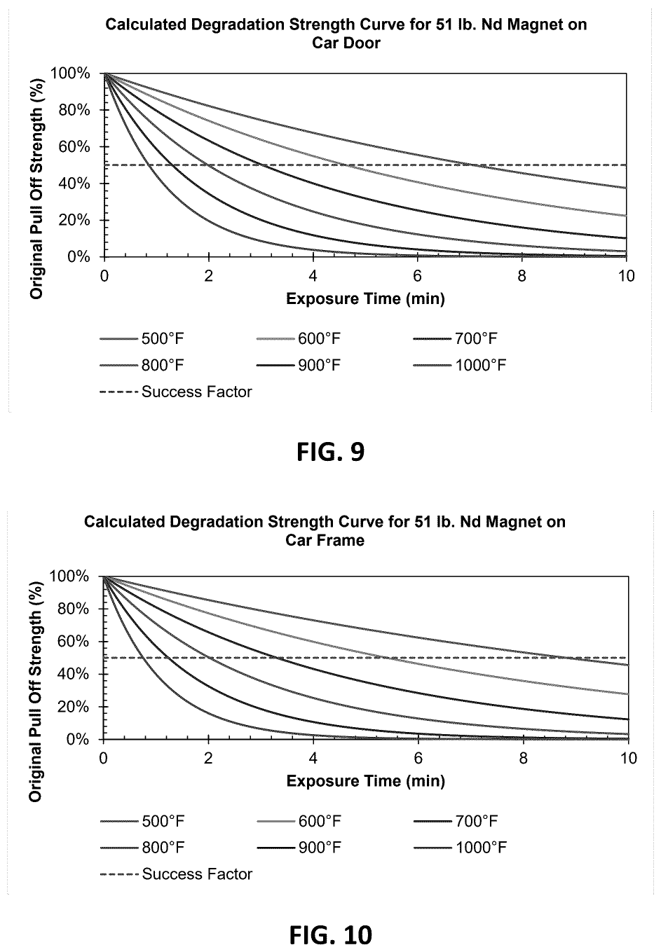

Focus was placed on 51 lb Neodymium since they exhibit the highest strength of the COTS trackers. Using the experimental data, a decay constant was determined using the Arrhenius equation to predict strength loss at various temperatures in FIGS. 9 and 10.

$$N = {N}_{0} {e}^{- kt} \qquad Arrhenius Equation$$

$${N}_{0} = Amount of Strength Loss at Time 0$$

$$N = Amount of final Strength Loss$$

$$k = Degradation Constant$$

$$t = variable of time$$

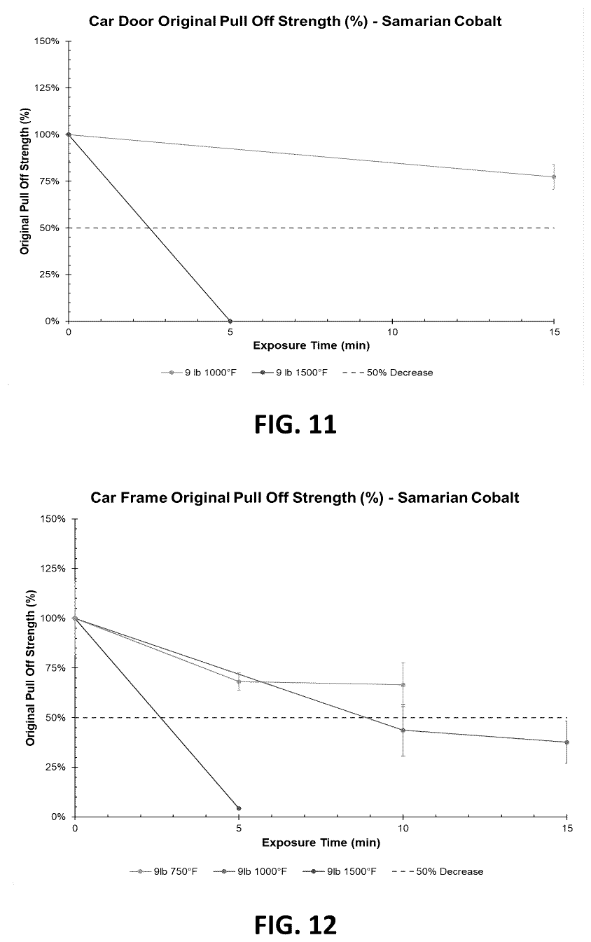

Samarian Cobalt magnets have a much higher Curie temp (1500° F.) and require higher and longer heat exposure than Neodymium (700° F.) to degrade strength. FIGS. 11 and 12 show the experimental degradation of strength after thermal exposure in a muffle oven.

The long exposure times and high temperatures required to thermally degrade the Samarian Cobalt magnets make it highly unlikely that the current edge heater design will be able to provide the thermal performance needed to reduce the strength. Since none of the COTS tracker cases found on the open market contained Samarian Cobalt magnets, likely due to the high cost, at this time testing will be limited to muffle oven exposure.

Based on the results of the oven thermal degradation, focus turned to experimenting with temperature and exposure time on car door panels using edge heaters. Two 2003 Honda Accord front car doors were purchased and cut down into smaller test panels. Safety protocols require that these edge heater tests be performed in a laboratory hood with adequate ventilation to accommodate fumes from thermal degradation by products such as automotive paint.

Individual 51 lb Neodymium magnets were placed on car door panels and exposed to 1, 2 and 3 edge heaters for an average of 30 minutes of at least 750° F. surface temperature. The pull strength of the magnets was tested after thermal exposure. As expected, adding additional edge heaters around the magnet provided a larger heated surface area, more thermal degradation and lower pull strengths were observed as compared to the original. One edge heater reduced the pull strength to about 80% of original, two edge heaters reduced to about 70% of original. Three edge heaters were required to run for at least 30 minutes at 750° F. to reduce the pull strength to about 44% and achieve the target of at least a 50% reduction of original pull strength.

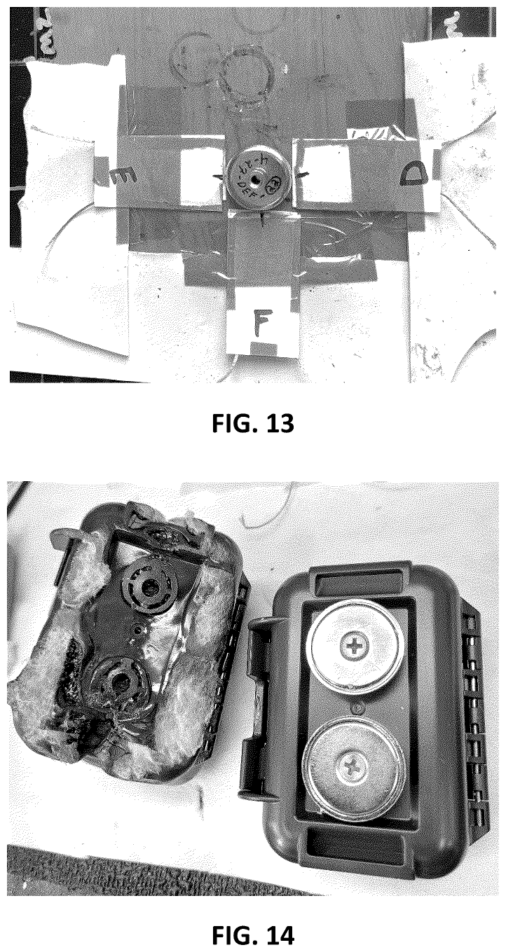

FIG. 13 shows an example test set up of one magnet with three edges heaters. The heaters are facing down towards the car door panel and kiln paper backers D, E and F are facing up towards the camera. The car door is painted with a red temperature indicating paint. Not shown in the photo is the ceramic fiber blanket placed over the heaters and auto panel to minimize heat loss to the air and maximize heating of the substrate.

As a similar and final test, two SpyTec tracker cases were applied to a car door panel (not shown). Several layers of white ceramic fiber blanket were placed over the heaters and under the tracker case. Each magnet was exposed to heat from three edge heaters for at least 30 minutes or until the heater failed, whichever came first.

The results in Table 4 show that the average % of original pull strength for each case was 32% and 38%. This exceeds the milestone target of at least a 50% reduction of pull-off strength with the use of edge heaters.

TABLE 4
Edge Heater Test on SpyTec Tracker Case
Edge Heater Data on Tracker Case + Magnets

| | | | | AVG | AVG % of | |
|---|---|---|---|---|---|---|
| | AVG Volts | AVG Current | Exposure | Temperature | Original | |
| Sample ID: | (V): | (A): | Time (min) | (° F.): | Strength: | STDEV: |
| 08-04 Right | 6.7 | 1.94 | 30 | 579.7 | 32.1% | 0.3% |
| (4/28/T): | | | | | | |
| 08-04 Right | 5.9 | 1.99 | 30 | 627.0 | | |
| (5/5/A): | | | | | | |
| 08-04 Right | 6.0 | 1.81 | 10 | — | | |
| (5/5/B): | | | | | | |
| 08-04 Left | 7.5 | 1.96 | 30 | 832.6 | | |
| (5/5/C): | | | | | | |
| 08-04 Left | 5.6 | 2.02 | 30 | 623.1 | | |
| (5/5/D): | | | | | | |
| 08-04 Left | 5.9 | 1.43 | 30 | — | | |
| (5/5/E): | | | | | | |
| 08-03 Right | 7.5 | 2.07 | 30 | 905.8 | 37.7% | 4.2% |
| (5/5/K): | | | | | | |
| 08-03 Right | 7.0 | 2.20 | 26 | 580.2 | | |
| (5/5/L): | | | | | | |
| 08-03 Right | 6.7 | 2.06 | 12 | — | | |
| (5/5/M): | | | | | | |
| 08-03 Left | 6.7 | 2.10 | 30 | 870.7 | | |
| (5/5/N): | | | | | | |
| 08-03 Left | 6.5 | 2.15 | 30 | 768.3 | | |
| (5/5/O): | | | | | | |
| 08-03 Left | 5.7 | 1.75 | 20 | — | | |
| (5/5/P): | | | | | | |

Unfortunately, even with several layers of ceramic fiber blanket for insulation, both tracker cases showed signs of thermal degradation and deformation. FIG. 14, left, shows one of the tracker cases after thermal edge heater testing with magnets removed and, on the right, shows an untested tracker case. Thermal isolation of the cases from the edge heaters will be optimized in future experimentation.

### CONCLUSIONS

We have successfully demonstrated the thermal performance of edge heaters in increasing the surface temperature of car door panels up to 1821° F. (milestone of at least 750° F.) and thermally degrading the Neodymium magnets in COTS tracker cases reducing the pull strength down to 35% of the original (milestone of at least 50% reduction). The time required to heat the small sections of door panels is around 30 minutes using multiple heaters and significant thermal insulation from the outside air. The heaters can be powered with rechargeable batteries similar to those found in drills or other typical power tools.

1. An edge heater, comprising
a resistive heating sheet having dimensions of length, width, and thickness;
wherein the thickness is at least 10 times less than length and at least 10 times less than width;
first and second electrical leads connected to the resistive heating sheet;
wherein the resistive heating sheet provides an electrically-conductive pathway from the first to the second electrical lead;
wherein the resistive heating sheet comprises a heating edge along the width of the resistive heating sheet;
wherein the edge opposite the heating edge comprises a reduced portion that creates a constriction region for the flow of electricity through the resistive heating sheet from the first to the second lead; and
wherein the resistive heating sheet has an asymmetrical shape in the length dimension such that, if a plane is drawn perpendicular to length and thickness and bisecting the constriction region, there is no reflection of the resistive heating sheet through the plane that extends over more than 20% of the heating edge and wherein the area of the resistive heating sheet on the heating edge side of the plane is less than the area of the resistive heating sheet on the side of the plane opposing the heating edge.

2. The edge heater of claim 1 wherein the resistive heating sheet comprises bucky paper.

3. The edge heater of claim 1 wherein the resistive heating sheet comprises at least 60 g/m² of CNTs. or at least 100 g/m² of CNTs or in the range of 50 to 400 g/m² of CNTs.

4. The edge heater of claim 1 wherein the area of the resistive heating sheet on the side of the plane opposing the heating edge is at least two times greater or at least 3 times greater or in the range of 2 to 100 times greater than the area of the resistive heating sheet on the heating edge side of the plane.

5. The edge heater of claim 1 wherein the resistive heating element has an appearance of 2D pants.

6. The edge heater of claim 1 wherein the thermally conductive material layer comprises a silver-containing adhesive is applied in a triangular shape at an intersection of a pair of legs of the pants-shaped heating element.

7. The edge heater of claim 1 wherein the adhesive that makes contact between the resistive heating element and kiln paper is a magnesia adhesive.

8. The edge heater of claim 1 wherein a ceramic fiber blanket, comprising alumina and silica fibers, is applied over one or both sides of the thin heating element to provide thermal insulation.

9. The edge heater of claim 1 is powered by rechargeable batteries capable of producing at least a voltage of 5 volts and at least a current of 1 amp.

10. The edge heater of claim 1 is able to reduce the pull strength of rare earth magnets to 30-50% or less of original pull strength after thermal exposure.

11. The edge heater of claim 1 wherein the ratio of length to width is 2 to 1, or 1.5 to 1, or between 1.0-2.5 to 0.5-2.0.

12. The edge heater of claim 1 wherein the heating edge forms an angle with the constriction region with the apex at the constriction region; wherein the angle is at least 160 degrees or at least 170 degrees or between 160 and 180 degrees.

13. The edge heater of claim 1 wherein the heating edge is planar such that the heating edge projects from said plane by a uniform distance (angle is 180 degrees).

14. The edge heater of claim 1 wherein the length of the edge heater is 1.5 inches, or 2 inches, or between 0.75 inches and 3.5 inches.

15. The edge heater of claim 1 wherein the width of the edge heater is 1 inch, or 1.5 inches, or between 0.5 and 3 inches.

16. The edge heater of claim 1 wherein the thickness of the edge heater is between 25 μm and 150 μm.

17. An edge heater comprising:
a resistive heating sheet having dimensions of height, width, and thickness and is asymmetrical in shape;
wherein the thickness is at least 10 times less than the length and at least 10 times less than the width;
wherein an edge that is a heating edge comprises a reduced portion, or a gap, that creates a constriction region for the flow of electricity through the resistive heating sheet from the first to the second lead;
wherein if a plane were to be drawn through the constriction region such that the axis were to bisect the constriction region in the width direction, the sheet on one side of the axis would extend further at every point away from the axis as compared to the other side, except for a single point, or a region that makes up 10% or less of the sheet's width, on both sides of the axis that is equidistant to the axis and lies on a single longitudinal axis;
first and second electrical leads connected to the resistive heating sheet;
wherein the resistive heating sheet provides an electrically-conductive pathway from the first lead through the constriction region to the second electrical lead; and
wherein the resistive heating sheet comprises a heating edge along the width of the resistive heating sheet that is closer to the axis than the sheet's edge that opposes the heating edge.

18. A system for heating an object, comprising;
an edge heater further comprising:
a resistive heating sheet having dimensions of height, width, and thickness and is asymmetrical in shape;
wherein the thickness is at least 10 times less than the length and at least 10 times less than the width;
wherein if a plane were to be drawn through the gap such that the axis bisects the gap, the sheet on one side of the axis would extend further at every point away from the axis as compared to the other side, except for a single point, or a region that makes up 10% or less of the sheet's width, on both sides that is equidistant to the transverse axis and lie on a single longitudinal axis;
first and second electrical leads connected to the resistive heating sheet;
wherein the resistive heating sheet provides an electrically-conductive pathway from the first lead through a constriction region to the second electrical lead;
wherein the resistive heating sheet comprises a heating edge along the width of the resistive heating sheet;
wherein an edge opposite the heating edge comprises a reduced portion, or a gap, that creates the constriction region for the flow of electricity through the resistive heating sheet from the first to the second lead;
an object to which the edge heater is applied is touching the edge heater on the heating edge but not on other sides of the resistive heating sheet; and
an electrical power source connected to the edge heater.

19. The system of claim 18 wherein electricity is passed through the constriction region of the resistive heating sheet and wherein the highest temperature of the resistive heating sheet is at least 2° C. (or at least 5° C.) hotter than the average temperature of the object.

20. The system of claim 18 wherein the object comprises a magnet.

21-31. (canceled)
